(19) United States
(12) Patent Application Publication
(10) Pub. No.: US 2026/0146140 A1
(43) Pub. Date: May 28, 2026

(54) CURABLE RESIN COMPOSITION, CURED PRODUCT, AND PIEZOELECTRIC BODY

(71) Applicant: OSAKA ORGANIC CHEMICAL INDUSTRY LTD., Osaka (JP)

(72) Inventors: Ryohei IKEDA, Kashiwara-shi (JP); Tomoya MIZUMORI, Kashiwara-shi (JP); Kouki TSUBAKI, Kashiwara-shi (JP)

(21) Appl. No.: 19/401,549

(22) Filed: Nov. 26, 2025

(30) Foreign Application Priority Data
Nov. 28, 2024 (JP) 2024-207324

(51) Int. Cl. C08K 3/22; C08K 5/3445; C08K 5/37; C08L 63/00

(52) U.S. Cl. CPC C08K 3/22; C08K 5/3445; C08K 5/37; C08L 63/00; C08K 2003/2237

(57) ABSTRACT

The present invention relates to a curable resin composition. The composition comprises piezoelectric particles (Al) having a Curie temperature (Tc) of 0.15 mJ/mg or more, an epoxy resin (B), and a curing agent (C).

### CROSS-REFERENCE TO RELATED APPLICATION

This application claims the benefit of Japanese Patent Application No. JP 2024-207324 filed Nov. 28, 2024, the contents of which are incorporated herein by reference in their entirety.

### TECHNICAL FIELD

The present invention relates to a curable resin composition, a cured product thereof, and a piezoelectric body.

### BACKGROUND ART

A piezoelectric material is a material that generates a voltage in response to strain caused by an applied pressure. Various polymeric components and polymeric materials containing piezoelectric particles are known as piezoelectric materials. For example, Patent Document 1 discloses a curable resin composition containing piezoelectric particles and a specific compound.

### PRIOR ART DOCUMENTS

### Patent Documents

Patent Document 1: WO 2023/032866.

### SUMMARY OF INVENTION

### Problems to be Solved by the Invention

In recent years, there has been a demand for flexible piezoelectric materials. Piezoelectric materials generate voltage in response to strain caused by applying pressure to the piezoelectric material. However, it has been found that when a piezoelectric material is flexible, the pressure applied to the piezoelectric material is alleviated by the flexibility of the material, and the piezoelectric properties may decrease compared to when pressure is applied to a hard material. The present disclosure is to provide a piezoelectric material that can achieve both flexibility and piezoelectric properties.

### Solution to Problem

The inventors investigated solutions to solve the above problem. As a result, they found that the problem can be solved by the curable resin composition described below. Therefore, the present invention includes the following preferred aspects.
[1] A curable resin composition comprising piezoelectric particles (A1) having a Curie temperature (Tc) of 0.15 mJ/mg or more, an epoxy resin (B), and a curing agent (C).
[2] The curable resin composition according to [1], wherein a cured product at a thickness of 200 μm obtained by heating the curable resin composition at 80° C. for 3 hours and at 140° C. for 3 hours to effect curing has a tensile elastic modulus of 100 MPa or less.
[3] The curable resin composition according to [1] or [2], wherein the epoxy resin (B) comprises an epoxy resin (B1) having a viscosity of 500 mPa's or less as measured at 25° C.
[4] The curable resin composition according to any one of [1] to [3], wherein the epoxy resin (B) comprises an epoxy resin (B2) represented by Formula (1).

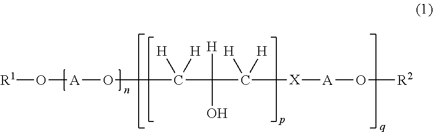

In Formula (1), A is a divalent alkylene group represented by —[(CH₂)ₘ]—, m independently at each occurrence representing an integer from 1 to 10; R¹ and R² are each independently a hydrogen atom or a glycidyl group, at least one of R¹ and R² being a glycidyl group; X represents a single bond, —O—, or —O-A—; n is an integer from 0 to 20; p is 0 or 1; and q is an integer from 0 to 20.
[5] The curable resin composition according to [3] or [4], wherein the proportion of the epoxy resin (B1) relative to the total amount of the epoxy resin (B) contained in the curable resin composition is 60 to 100% by mass
[6] The curable resin composition according to any one of [1] to [5], wherein the piezoelectric particles (A1) are barium titanate.
[7] The curable resin composition according to any one of [1] to [6], wherein the proportion of the piezoelectric particles (A1) relative to the total amount of the piezoelectric particles (A) contained in the curable resin composition is 60 to 100% by mass.
[8] The curable resin composition according to any one of [1] to [7], wherein the mass ratio of piezoelectric particles (A1):epoxy resin (B):curing agent (C) is 65 to 90:5 to 30:0.5 to 5.
[9] The curable resin composition according to any one of [1] to [8], wherein the viscosity measured at 25° C. is 100 Pa's or less.
[10] A cured product of the curable resin composition according to any one of [1] to [9].
[11] A piezoelectric body comprising piezoelectric particles (A1) having a Curie temperature (Tc) of 0.15 mJ/mg or more and an epoxy-based binder; wherein the tensile elastic modulus at 25° C. is 100 MPa or less, and the piezoelectric constant d₃₃ is 30 or more.

### Effects of the Invention

According to the present invention, it is possible to provide a piezoelectric material that can achieve both flexibility and piezoelectric properties.

### DETAILED DESCRIPTION

The embodiments of the present disclosure will be described in detail below. The scope of the present invention is not limited to the embodiments described herein, and various modifications can be made without departing from the spirit of the present invention. In the specification, numerical ranges indicated by the term “to” include the lower and upper limits.

The curable resin composition of the present disclosure is a curable resin composition comprising piezoelectric particles (A1) having a Curie temperature (Tc) of 0.15 mJ/mg or more, an epoxy resin (B), and a curing agent (C).

### (Piezoelectric Particles)

The curable resin composition contains piezoelectric particles (A1) having a Curie temperature (Tc) of 0.15 mJ/mg or more. The term “piezoelectric particles” refers to particles having piezoelectricity, and examples include piezoelectric ceramics having a perovskite crystal structure. Examples of piezoelectric particles having a Curie temperature of 0.15 mJ/mg or more include barium titanate, lead zirconate titanate, potassium sodium niobate, and lithium tantalate. The curable resin composition of the present disclosure may contain one kind of piezoelectric particles, or two or more kinds, but is a composition that contains at least piezoelectric particles (A1) having a Curie temperature (Tc) of 0.15 mJ/mg or more.

The Curie temperature (Tc) of the piezoelectric particles (A1) is 0.15 mJ/mg or more from the viewpoint of improving piezoelectric properties, preferably from 0.15 to 2.00 mJ/mg, more preferably from 0.30 to 1.50 mJ/mg, and even more preferably from 0.45 to 1.00 mJ/mg. The Curie temperature of the particles can be measured by differential scanning calorimetry (DSC). The Curie temperature (Tc) can be adjusted within the above range by applying publicly known methods. In particular, in the case of piezoelectric ceramics having a perovskite crystal structure represented by the chemical formula ABO3, examples include modifying the metal atoms represented by A or B and/or adjusting their weight ratio. Here, A (R) denotes a metal atom located at the vertices of the unit cell, B (M) denotes a metal atom located at the body center of the unit cell, and O(O) denotes oxygen located at the centers of the faces.

The average particle diameter (median diameter, D50) of the piezoelectric particles is, from the viewpoint of balancing flexibility and piezoelectric properties of the piezoelectric material, preferably from 0.1 to 20 μm, more preferably from 0.2 to 17.5 μm, and even more preferably from 0.5 to 15 μm. The average particle diameter (D50) can be measured using a particle size distribution analyzer. The curable resin composition may contain one kind of piezoelectric particles. However, from the viewpoints of improving the flowability of the curable resin composition and balancing flexibility and piezoelectric properties of the piezoelectric material, it is preferable that the curable resin composition contain two or more kinds of piezoelectric particles having different average particle sizes (D50).

The content of the piezoelectric particles (A1) contained in the curable resin composition of the present disclosure is, relative to the total amount of the curable resin composition, preferably from 50 to 95% by mass, more preferably from 60 to 92% by mass, and even more preferably from 65 to 90% by mass.

The proportion of the piezoelectric particles (A1) relative to the total amount of piezoelectric particles (A) contained in the curable resin composition is, from the viewpoint of balancing flexibility and piezoelectric properties of the piezoelectric material, preferably from 60 to 100% by mass, more preferably from 70 to 100% by mass, still more preferably from 80 to 100% by mass, and particularly preferably from 90 to 100% by mass.

From the viewpoint of the piezoelectric properties of the piezoelectric material, the piezoelectric particles (A1) contained in the curable resin composition preferably have large crystallites constituting each particle in order to obtain a high heat quantity at Tc. The term “crystallite” refers to a region in a substance having a crystal structure in which a single crystal lattice is perfectly ordered. For example, the average size of the crystallites constituting the piezoelectric particles (A) is preferably 235 Å or more, and more preferably 240 Å or more. The upper limit of the crystallite size is not particularly limited, from the view point of the crystallite sizes of piezoelectric particles obtainable in general, it is generally about 400 Å or less. The crystallite size of the piezoelectric particles can be measured by X-ray diffraction (XRD).

### (Epoxy Resin)

The curable resin composition of the present disclosure further contains an epoxy resin (B). The epoxy resin (B) is not particularly limited as long as it is a resin having an epoxy group. Examples of the epoxy resin (B) include polymethylene oxide-type epoxy resins, polyol-type epoxy resins, bisphenol A-type epoxy resins, bisphenol F-type epoxy resins, cycloalkyl-type epoxy resins, phenol novolac-type epoxy resins, dimer acid-modified epoxy resins, and silicone-modified epoxy resins. The curable resin composition of the present disclosure may contain one kind of the epoxy resin (B) or two or more kinds of the epoxy resin (B).

From the viewpoint of balancing flexibility and piezoelectric properties of the piezoelectric material, the viscosity of the epoxy resin (B) as measured at 25° C. is preferably from 10 to 1,000 mPa's, more preferably from 100 to 900 mPa's, and still more preferably from 200 to 750 mPa·s. The viscosity of the epoxy resin (B) can be measured using an E-type viscometer.

From the viewpoint of balancing flexibility and piezoelectric properties of the piezoelectric material, the epoxy equivalent of the epoxy resin (B) is preferably from 100 to 1,000, more preferably from 200 to 800, still more preferably from 250 to 700, and even more preferably from 300 to 600. The epoxy equivalent of the epoxy resin (B) can be calculated from the number of 8997000-4 functional groups of the epoxy resin (B) and the weight-average molecular weight of the epoxy resin (B).

From the viewpoint of balancing flexibility and piezoelectric properties of the piezoelectric material, the weight-average molecular weight of the epoxy resin (B) is preferably from 100 to 5,000, more preferably from 200 to 2,500, and even more preferably from 300 to 1,000. The weight-average molecular weight of the epoxy resin (B) can be measured by gel permeation chromatography (GPC).

In a preferred embodiment, the epoxy resin (B) comprises an epoxy resin (B1) having a viscosity of 500 mPas or less as measured at 25° C. From the viewpoint of balancing flexibility and piezoelectric properties of the piezoelectric material, the viscosity of the epoxy resin (B1) as measured at 25° C. is preferably from 10 to 400 mPa's, more preferably from 100 to 300 mPa·s. The viscosity of the epoxy resin (B1) can be measured with an E-type viscometer.

From the viewpoint of balancing flexibility and piezoelectric properties of the piezoelectric material, the epoxy equivalent of the epoxy resin (B1) is preferably from 100 to 1,000, more preferably from 200 to 800, still more preferably from 250 to 700, and even more preferably from 300 to 600. The epoxy equivalent of the epoxy resin (B1) can be calculated from the number of functional groups of the epoxy resin (B1) and the weight-average molecular weight of the epoxy resin (B1).

From the viewpoint of balancing flexibility and piezoelectric properties of the piezoelectric material, the weight-average molecular weight of the epoxy resin (B1) is preferably from 100 to 5,000, more preferably from 200 to 2,500, and even more preferably from 300 to 1,000. The weight-average molecular weight of the epoxy resin (B1) can be measured by gel permeation chromatography (GPC).

The content of the epoxy resin (B) in the curable resin composition is preferably from 7 to 30% by mass, more preferably from 8 to 20% by mass, and even more preferably from 9 to 15% by mass, relative to the total amount of the curable resin composition.

From the viewpoint of balancing flexibility and piezoelectric properties of the piezoelectric material, the content of the epoxy resin (B1) in the curable resin composition is preferably from 7 to 40% by mass, more preferably from 8 to 35% by mass, and even more preferably from 9 to 30% by mass, relative to the total amount of the curable resin composition.

From the viewpoint of balancing flexibility and piezoelectric properties of the piezoelectric material, the proportion of the epoxy resin (B1) to the total amount of the epoxy resin (B) contained in the curable resin composition is preferably from 60 to 100% by mass, more preferably from 70 to 100% by mass, and even more preferably from 80 to 100% by mass.

In a preferred embodiment, the epoxy resin (B) comprises an epoxy resin (B2) represented by the following Formula (1).

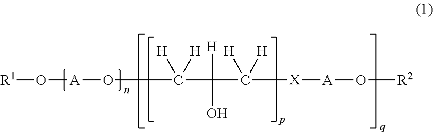

In Formula (1), A is a divalent alkylene group represented by —[(CH₂)ₘ]—, m each independently representing an integer from 1 to 10; R¹ and R² are each independently a hydrogen atom or a glycidyl group, at least one of R¹ and R² being a glycidyl group; X represents a single bond, —O—, or —O-A-; n is an integer of from 0 to 20; p is 0 or 1; and q is an integer of from 0 to 20.

From the viewpoints of availability and manufacturability, in the epoxy resin (B2) of Formula (1) above, n is preferably from 0 to 10, and q is preferably from 0 to 10. The epoxy resin (B2) may be a mixture of a plurality of structurally different epoxy resins (B2).

The epoxy equivalent and the weight-average molecular weight of the epoxy resin (B2), the content of the epoxy resin (B2) in the curable resin composition, and the proportion of the epoxy resin (B2) relative to the total amount of the epoxy resin (B) contained in the curable resin composition are the same as those of the epoxy resin (B1). The epoxy resin (B2) may be the epoxy resin (B1).

The structure of the epoxy resin can be determined by nuclear magnetic resonance (NMR) measurement.

### (Curing Agent)

The curable resin composition of the present disclosure further contains a curing agent (C). The curing agent (C) is not particularly limited as long as it is a component capable of curing the epoxy resin. Examples of curing agent (C) include amine-type curing agents, thiol-type curing agents, imidazole-type curing agents, acid anhydride-type curing agents, polyamide-type curing agents, urea-type curing agents, cationic curing agents, and metal-salt curing agents. The curable resin composition of the present disclosure may contain one kind of curing agent or two or more kinds of curing agents. The curing agent (C) is preferably an amine-type curing agent and more preferably an imidazole-type curing agent or a thiol-type curing agent. From the viewpoint of stability of the composition, the content of the curing agent (C) is preferably from 0.1 to 10% by mass, more preferably from 0.5 to 7.5% by mass, and even more preferably from 1.0 to 5% by mass, relative to the total amount of the curable resin composition. From the viewpoint of curing the curable resin composition, the content of the curing agent (C) is preferably from 1 to 60% by mass, more preferably from 2.5 to 45% by mass, and even more preferably from 5 to 30% by mass, relative to the total amount of the epoxy resin (B) contained in the curable resin composition.

### (Other Components)

The curable resin composition of the present disclosure may further contain other components in addition to the above components. Examples of the other components include dispersants, curable resins other than epoxy resins, curable monomers, and silane coupling agents.

The dispersant is a component capable of improving the dispersibility of the piezoelectric particles in the curable resin composition. Examples of the dispersant include surfactants such as anionic surfactants, cationic surfactants, nonionic surfactants, and amphoteric surfactants; polysorbates; polycarboxylic acids; and silane coupling agents. The dispersant is preferably a nonionic surfactant or a polysorbate, and more preferably a polysorbate. The content of the dispersant in the curable resin composition is preferably from 0.01 to 10% by mass, more preferably from 0.05 to 5% by mass, and even more preferably from 0.1 to 2.5% by mass, relative to the total amount of the curable resin composition.

The curable resin composition of the present disclosure may contain curable resins other than epoxy resins. Examples of the curable resins other than epoxy resins include acrylic resins, polyurethane resins, and silicone resins. From the viewpoint of balancing flexibility and piezoelectric properties of the piezoelectric material, the content of the curable resins other than epoxy resins is preferably from 0 to 5% by mass, more preferably from 0 to 2.5% by mass, and even 8997000-4 more preferably from 0 to 1% by mass, relative to the total amount of the curable resin composition.

The curable resin composition of the present disclosure may further contain a curable monomer. Examples of the curable monomer include monomers having a (meth)acrylate group, monomers having an oxetane group, and monomers having a maleimide group. From the viewpoint of balancing flexibility and piezoelectric properties of the piezoelectric material, the content of the curable monomer is preferably small; specifically, preferably from 0 to 5% by mass, more preferably from 0 to 2.5% by mass, and even more preferably from 0 to 1% by mass, relative to the total amount of the curable resin composition.

### (Curable Resin Composition)

The curable resin composition of the present disclosure is a composition comprising piezoelectric particles (A1) having a specific Curie temperature, an epoxy resin (B), and a curing agent (C). From the viewpoint of balancing flexibility and piezoelectric properties of the piezoelectric material, the total content of the piezoelectric particles (A1), the epoxy resin (B), and the curing agent (C) is preferably from 90 to 100% by mass, more preferably from 95 to 100% by mass, and even more preferably from 99 to 100% by mass, relative to the total amount of the curable resin composition.

From the viewpoint of balancing flexibility and piezoelectric properties of the piezoelectric material, the mass ratio of the piezoelectric particles (A1):epoxy resin (B):curing agent (C) contained in the curable resin composition of the present disclosure is preferably from 65 to 90: from 5 to 30: from 0.5 to 5 and more preferably from 67 to 87: from 9 to 29: from 1 to 4.

From the viewpoint of balancing flexibility and piezoelectric properties of the piezoelectric material, the average Tc heat quantity of the piezoelectric particles that calculated by weighted averaging the Curie temperatures of the piezoelectric particles contained in the curable resin composition of the present disclosure, is preferably from 0.15 to 2.00 mJ/mg, more preferably from 0.30 to 1.50 mJ/mg, and even more preferably from 0.45 to 1.00 mJ/mg.

In the curable resin composition of the present disclosure, the cured product of the epoxy resin (B) works as a binder. From the viewpoint of balancing flexibility and piezoelectric properties of the piezoelectric material, the dielectric constant of the binder alone is preferably 3.1 or more, more preferably 3.5 or more, and even more preferably 4.0 or more. The upper limit of the dielectric constant is not particularly limited, and may be, for example, 7.0 or less. The dielectric constant of the binder alone can be measured by an impedance analyzer using a cured product obtained by removing solid content such as piezoelectric particles from a curable resin composition and heating it at 80° C. for 3 hours and then at 140° C. for 3 hours to cure it as a measurement sample.

The tensile elastic modulus of the cured product of the curable resin composition obtained by cured by heating at 80° C. for 3 hours and at 140° C. for 3 hours, and having a thickness of 200 μm is preferably 100 MPa or less, more preferably 75 MPa or less, and even more preferably 50 MPa or less. The lower limit of the tensile elastic modulus of the cured product is not particularly limited, but may be, for example, 0.1 MPa or more. The tensile elastic modulus of the cured product can be measured, for example, by the method described in the Examples.

The viscosity of the curable resin composition of the present disclosure, as measured at 25° C., is 100 Pa's or less, more preferably from 20 to 100 Pa's, still more preferably from 25 to 80 Pa·s, and even more preferably from 27.5 to 60 Pa·s. The viscosity of the curable resin composition can be measured using a rheometer. Specifically, measurement may be started using a 25 mm parallel plate, at 25° C. and a rotational speed of 5 min 1, and the viscosity at 180 seconds from the start of measurement may be adopted.

### (Method for Preparing the Curable Resin Composition)

The curable resin composition of the present disclosure can be produced by mixing the above components by conventionally known methods.

### (Cured Product of the Curable Resin Composition)

The present disclosure also provides a cured product of the curable resin composition. The cured product of the curable resin composition can be prepared by heating the curable resin composition of the present disclosure to cure the curable resin contained in the curable resin composition. The curing temperature is not particularly limited, but the composition can be prepared by heating preferably from 50 to 200° C., more preferably from 65 to 160° C. The heating time is preferably from 0.5 to 6 hours, and more preferably from 1 to 4 hours.

### (Piezoelectric Body)

The present disclosure also provides a piezoelectric body that is a cured product of the above curable resin composition. In a preferred embodiment, the piezoelectric body comprises piezoelectric particles (A1) having a Curie temperature (Tc) of 0.15 mJ/mg or more and an epoxy-based binder; the tensile elastic modulus at 25° C. is 100 MPa or less, and the piezoelectric constant d₃₃ is 30 or more. The piezoelectric particles (A1) are the piezoelectric particles (A1) described in the curable resin composition. The epoxy-based binder is the cured resin of the epoxy resin (B) described in the curable resin composition.

The method of producing the piezoelectric body is not particularly limited. For example, the piezoelectric body of the present disclosure can be produced by applying the curable resin composition of the present disclosure to a substrate, curing the epoxy resin (B) to obtain a cured product, and applying an AC voltage and/or a DC voltage to the cured product to perform a polarization treatment, thereby generating piezoelectric properties in the cured product.

The piezoelectric properties of the piezoelectric body of the present disclosure can be expressed, for example, by the piezoelectric constant d₃₃. The piezoelectric body of the present disclosure preferably has a piezoelectric constant d₃₃ of 30 or more, more preferably 60 or more, and even more preferably 100 or more, as measured by the measurement method for the piezoelectric constant d₃₃ described in the Examples below. The upper limit of the piezoelectric constant d₃₃ is not particularly limited, and may be, for example, 200 or less.

The piezoelectric body of the present disclosure is a piezoelectric material that balancing flexibility and piezoelectric properties, for example, it is suitable as component for pressure sensors, pyroelectric sensors, and flexible memory elements, and is particularly suitable as component for wearable sensors, actuators, flat speakers, transducers, and piezoelectric wires.

The reason why the piezoelectric body of the present disclosure can achieve both flexibility and piezoelectric properties is not limited by theory, the inventors discovered that when the particle size of the piezoelectric particles is the same, particles having larger crystallites constituting each particle exhibit higher piezoelectric performance. First, the inventors discovered that the Curie temperature (Tc) of the piezoelectric particles relates to the size of the crystallites constituting each particle. Specifically, the size of crystallites constituting each particle of piezoelectric particles is large, indicate that each particle is composed of large crystallites and, the number of crystallites constituting a one particle is small. As a result, it can be said that the surface area of the crystallites of the particle is small making it difficult for heat to be transmitted so that the size of the crystallites constituting each particle of piezoelectric particles is larger, the heat amount of the Curie temperature (Tc) of the piezoelectric particles is large. In other words, piezoelectric particles with a low Curie temperature (Tc) have a large number of crystallites constituting each particle, so that distortion is likely to occur in each crystallite during polarization treatment, and there is a high probability that the polarization direction of each crystallite will not be consistent, making it easy for the polarization of each crystallite within a particle to cancel each other out. On the other hand, if the crystallites constituting each piezoelectric particle are large, the probability that the polarization direction of each crystallite will be random is low, and the polarization of each crystallite within a particle is less likely to cancel out, and as a result, each piezoelectric particle is thought to have high piezoelectric performance. Furthermore, piezoelectric particles tend to exhibit high piezoelectric properties when polarized in an environment with a high dielectric constant (for example, in a resin with a high dielectric constant), the cured product of the epoxy binder constituting the curable resin composition of the present disclosure exhibits a relatively high dielectric constant, which is thought to contribute to an improvement in the polarization amount of the piezoelectric particles. Furthermore, the piezoelectric material of the present disclosure is flexible but does not exhibit plastic (irreversible) behavior when an external force is applied, and the stress applied during elastic deformation is greater on the piezoelectric particles (the stress is less likely to be absorbed by the binder), which is thought to enable both flexibility and piezoelectric properties to be achieved.

### EXAMPLES

The present invention will be described in more detail with Examples.However these examples are provided for illustrative purposes only and are not intended to limit the present invention. Unless otherwise specified, the symbols “%” and “parts” in the Examples mean “% by mass” and “parts by mass,” respectively. The chemical names given below do not necessarily conform to IUPAC nomenclature.

First, the materials used in the Examples and Comparative Examples are described below.

### (Piezoelectric Particles A)

| | | | | Median |
|---|---|---|---|---|
| | | | Tc | size |
| | | Product name | [mJ/mg] | D50 [μm] |
| A1-1 | Barium titanate | PALCERAM BTE-UP | 0.57 | 10 |
| | particles | (Nippon Chemical | | |
| | | Industrial Co., Ltd.) | | |
| A1-2 | Barium titanate | BT-05 (Sakai Chemical | 0.53 | 1 |
| | particles | Industry Co., Ltd.) | | |
| A1-3 | Barium titanate | BT-03 (Sakai Chemical | 0.23 | 0.67 |
| | particles | Industry Co., Ltd.) | | |
| A1-4 | Barium titanate | PALCERAM BT-UP2 | 0.06 | 2 |
| | particles | (Nippon Chemical | | |
| | | Industrial Co., Ltd.) | | |
| A1-5 | Potassium sodium | KN10 | 1.5 | 10 |
| | niobate particles | (DIC Corporation) | | |
| A1-6 | Potassium sodium | KN3 | 1.5 | 3 |
| | niobate particles | (DIC Corporation) | | |
| A′-1 | Barium titanate | PALCERAM BTC-5B | 0.05 | 1 |
| | particles | (Nippon Chemical | | |
| | | Industrial Co., Ltd.) | | |

### (Epoxy Resin B)

B-1: Liquid epoxy resin; product name jER YX7400N (Mitsubishi Chemical Corp.); viscosity (25° C.): 0.2 Pa·s; weight-average molecular weight: 880 g/mol; epoxy equivalent: 440 g/eq.

B-2: Bisphenol A diglycidyl ether, product name jER828EL (Mitsubishi Chemical Corp.); viscosity: 13 Pa's; weight-average molecular weight: 380 g/mol; epoxy equivalent: 190 g/eq.

### (Curing Agent C)

C-1: Pentaerythritol tetrakis(3-mercaptobutylate); product name Karenz MT PE1 (Resonac Corp.).

C-2:1-Benzyl-2-phenylimidazole; product name CUREZOL (Shikoku Chemical Corp.).

C-3: m-Xylylenediamine; product name MXDA (Mitsubishi Gas Chemical Co., Inc.).

### (Polymerizable Compound D)

D-1: Acryloyl-terminated polyacrylate; product name KANEKA XMAP RC100C (Kaneka Corp.).

D-2: Hydrogenated polybutadiene diacrylate (SPBDA), synthesized according to Synthesis Example 1 described below.

D-3: Isodecyl acrylate; product name IDAA (Osaka Organic Chemical Industry, Ltd.).

D-4:4-Hydroxybutyl acrylate; product name 4-HBA (Osaka Organic Chemical Industry, Ltd.).

D-5: Acryloyl morpholine; product name ACMO (KJ Chemicals Corp.).

D-6:2-Acryloyloxyethyl succinate; product name HOA-MS (Kyoeisha Chemical Co., Ltd.).

### (Polymerization Initiator E)

E-1: t-Butyl peroxy-2-ethylhexanoate; product name PERBUTYL O(NOF Corporation).

### (Dispersant F (Surfactant))

F-1: Sorbitan trioleate; product name Rheodol SP-030V (Kao Corp.).

The physical properties of the piezoelectric particles, epoxy resins, resin compositions, or cured products of the resin compositions were measured by the following methods.

### <Curie Temperature>

The Curie temperature of each piezoelectric particle A described above was measured by differential scanning calorimetry (DSC). Specifically, 10 mg of each piezoelectric particle was weighed and packed into an aluminum pan, and the temperature was raised from 30° C. to 200° C. at a heating rate of 10° C./min to measure the Curie temperature. The heat amount was obtained by dividing the integral of the DSC curve at the Curie temperature by the sample weight.

### (Tc Heat Amount of Piezoelectric-Particle (Average Tc))

The average Tc heat amount of the piezoelectric particles A was shown in Table 1. However, when the resin composition contained one type of piezoelectric particle, the Curie temperature of the piezoelectric particles was used as the average Tc heat value. When the resin composition contains two or more types of piezoelectric particles, the Curie temperatures (Tc) of the piezoelectric particles contained in the examples and comparative examples measured as described above were weighted averaged based on their blending ratios, and the values were listed in Tables 1 and 2 as the “Tc heat value of the piezoelectric particles.”

### (Weight-Average Molecular Weight)

The weight-average molecular weight was measured by gel permeation chromatography (GPC). Specifically, the resin was dissolved in tetrahydrofuran to obtain a 0.5% by mass solution, which was used as the measurement sample. The measurement conditions were as follows:
Instrument: HLC-8320GPC (Tosoh Corp.)
Column: TSKgel SuperH2500 (Tosoh Corp.)
Eluent: Tetrahydrofuran
Flow rate: 0.6 mL/min
Temperature: 40° C.
Detector: RI
Molecular-weight standard: Polystyrene

### (Viscosity of Epoxy Resin B)

The viscosity of epoxy resin B was measured using an E-type viscometer (TVE-100EH, TOKI Sangyo Co., Ltd.). Measurement was started under the conditions of rotor 1°34′×R24, 25° C., and rotational speed 20 min 1, and the viscosity at 180 seconds from the start of measurement was taken as the viscosity of epoxy resin B.

### Synthesis Example 1

### (Synthesis of Hydrogenated Polybutadiene Diacrylate (SPBDA))

A 300-mL four-necked flask equipped with a Dean-Stark separator and a stirrer was charged with 100.0 g of hydroxyl-terminated hydrogenated polybutadiene (hydrogenation ratio≥97%; CRAY VALLEY, trade name “HLB—H—P2000”), 23.6 g of methyl acrylate, 50.0 g of n-hexane, and 0.2 g of di-n-octyltin oxide, and the mixture was reacted for 8 hours at the reflux temperature while removing the formed methanol. After completion of the reaction, the solvent was removed by concentration to obtain 100.5 g of a yellow viscous liquid, bisacryloylated hydrogenated polybutadiene. The weight average molecular weight (Mw) of the resulting bisacrylated hydrogenated polybutadiene determined by GPC was 4,400.

### Preparation of the Curable Resin Composition

Each component was mixed at room temperature according to the formulations shown in Tables 1 and 2 to prepare the respective curable resin compositions, and the viscosity was measured under the conditions described below. The amounts of each component shown in the tables denote mass percent relative to the entire curable resin composition excluding the solvent. The Tc heat value of the piezoelectric particles contained in each example and comparative example is a theoretical value (average Tc heat value) calculated by taking a weighted average of the Curie temperature (Tc) of each piezoelectric particle contained in each example and comparative example and its blending ratio.

### Viscosity

The viscosity of each curable resin composition was measured with a rheometer (Anton Paar, MCR 302). Measurement was started using 25 mm parallel plates at 25° C. and a rotation speed of 5 min⁻¹, and the viscosity measured 180 seconds after the start of measurement was taken as the viscosity of each curable resin composition. The results are shown in Tables 1 and 2.

### Measurement of Properties of Cured Products

Using the above curable resin compositions, the following tests were performed to measure the properties of the cured products, and the results are shown in Tables 1 and 2.

(Piezoelectric Constant d₃₃)

### Preparation of Test Specimens

Each curable resin composition obtained above was applied onto a stainless-steel panel (MiSUMi Corp., material: SUS304, 100 mm×200 mm flat plate) using an applicator set to a gap of 400 μm, and was placed in a hot-air dryer (LC-113, ESPEC Corp.) set at 80° C. for 3 hours, then further heated to 140° C. and held for 3 hours. Thereafter, the sample was slowly cooled to room temperature to obtain test specimens (cured products) for the respective Examples and Comparative Examples. The thickness of each specimen was measured with a coolant-proof micrometer (MDC-25MX, Mitutoyo Corp.) and was found to be approximately 200 μm.

### Poling Treatment

Each test specimen obtained above was attached to a ground electrode and subjected to a poling treatment using an electret forming device (Wedge Co., Ltd.) by applying a voltage of −12 kV for 120 minutes.

### Measurement of Piezoelectric Constant d₃₃

After peeling each polarized test piece from the stainless-steel panel, nine points were selected within a 50 mm (vertical)×50 mm (horizontal) region such that each point was at least 15 mm apart from the others, and the piezoelectric constant d₃₃ was measured using a piezoelectric-constant measuring device (Lead Techno Co., model LPF-02). Specifically, the measurement was carried out according to the following procedure:
(1) The film was clamped with the probe.
(2) The load applied from the probe to the film was set to 1 N and held.
(3) The amount of charge A generated when a force of 1 N was applied was measured.
(4) The load applied from the probe to the film was increased by 3 N so that the load became 4 N.
(5) The amount of charge B generated when a force of 4 N was applied was measured.
(6) The load applied from the probe to the film was decreased by 3 N to 1 N.
(7) Steps (3) to (6) were performed four times; the average of the differences (A-B) obtained in the 2nd to 4th measurements was taken as the charge amount of the film for each Example and Comparative Example, and the piezoelectric constant d₃₃ of each specimen was calculated by dividing this average charge amount by the applied load (3 N). The results are shown in Tables 1 and 2.

### (Tensile Elastic Modulus)

### Preparation of Test Specimens

After the above measurement of the piezoelectric constant d₃₃, each test piece was punched into a dumbbell shape No. 7 as specified in 6.1 of JIS K6251 (2017) to obtain test pieces for measuring the tensile elastic modulus.

### Measurement of Tensile Elastic Modulus

Each test piece obtained above was mounted on a tensile tester (A&D Co., Ltd., Tensilon RTG-1310) at 25° C. so that the distance between chucks was 19 mm, and a tensile load was applied at a crosshead speed of 50 mm/min until fracture. The tensile elastic modulus was calculated from the slope of the tensile stress within a strain range of 3-5%. The results are shown in Tables 1 and 2.

(Evaluation Based on the Relationship Between Tensile Elastic Modulus and Piezoelectric Constant d₃₃)

In view of the relationship between the tensile elastic modulus and the piezoelectric constant d₃₃, the test pieces of the respective Examples and Comparative Examples were evaluated according to the following criteria. Note that the relationship between tensile elastic modulus and piezoelectric constant d₃₃ also varies depending on the content of the piezoelectric particles and the application in which the piezoelectric material is used; therefore, the following relationship is not necessarily preferable in all cases. In this application, in order to compare the effects of resin compositions containing piezoelectric particles at roughly the same content, evaluation was performed according to the following criteria.
(1) When the tensile elastic modulus is less than 5:
A: d₃₃ is 15 or more
B: d₃₃ is less than 15
(2) When the tensile elastic modulus is 5 or more and less than 25:
S: d₃₃ is 80 or more
A: d₃₃ is 30 or more
B: d₃₃ is less than 30
(3) When the tensile elastic modulus is 25 or more and less than 50:
S: d₃₃ is 80 or more
A: d₃₃ is 50 or more
B: d₃₃ is less than 50
(4) When the tensile elastic modulus is 50 or more:
A: d₃₃ is 60 or more
B: d₃₃ is less than 60

### (Cracking)

Each test piece was prepared in the same manner as the test pieces for measuring the tensile elastic modulus described above, and the test piece was held at both ends and bent until the plate portions at both ends were parallel. The state of the test piece was evaluated according to the following criteria.

◯: No cracking observed visually
×: Cracking observed visually

No cracking was observed in the test pieces obtained in Examples 1-7 and 9-15, indicating high toughness, whereas cracking was observed in the test pieces of Example 8. No cracking was observed in the specimens obtained in Comparative Examples 1-5.

### (Dielectric Constant of Binder Resin)

After preparing a resin composition that did not contain piezoelectric particles A, the cured product was prepared as described above and measured using an impedance analyzer (1260A, AMETEK Co.) to obtain the dielectric constant at 1 KHz.

TABLE 1

| | | Example | | | | | | | | Comparative example | | |
|---|---|---|---|---|---|---|---|---|---|---|---|---|
| | | 1 | 2 | 3 | 4 | 5 | 6 | 7 | 8 | 1 | 2 | 3 |
| Piezoelectric | A 1 - 1 | 42.5 | 42.5 | 42.5 | 42.5 | 42.5 | 42.5 | 63.75 | 69 | 0 | 42.5 | 42.5 |
| Particles A | A 1 - 2 | 42.5 | 42.5 | 42.5 | 42.5 | 42.5 | 42.5 | 21.25 | 23 | 0 | 42.5 | 42.5 |
| | A 1 - 3 | 0 | 0 | 0 | 0 | 0 | 0 | 0 | 0 | 0 | 0 | 0 |
| | A 1 - 4 | 0 | 0 | 0 | 0 | 0 | 0 | 0 | 0 | 0 | 0 | 0 |
| | A 1 - 5 | 0 | 0 | 0 | 0 | 0 | 0 | 0 | 0 | 0 | 0 | 0 |
| | A 1 - 6 | 0 | 0 | 0 | 0 | 0 | 0 | 0 | 0 | 0 | 0 | 0 |
| | A′- 1 | 0 | 0 | 0 | 0 | 0 | 0 | 0 | 0 | 85 | 0 | 0 |
| Epoxy Resin B | B - 1 | 13.5 | 11.5 | 11.9 | 12.2 | 8.54 | 11.95 | 13.5 | 6.5 | 13.5 | 0 | 0 |
| | B - 2 | 0 | 0 | 0 | 0 | 3.66 | 0.25 | 0 | 0 | 0 | 0 | 0 |
| Curing Agent C | C - 1 | 0 | 2.9 | 2.5 | 2.2 | 2.2 | 2.2 | 0 | 0 | 0 | 0 | 0 |
| | C - 2 | 0 | 0.1 | 0.1 | 0.1 | 0.1 | 0.1 | 0 | 0 | 0 | 0 | 0 |
| | C - 3 | 1.0 | 0 | 0 | 0 | 0 | 0.0 | 1.0 | 1.0 | 1.0 | 0 | 0 |
| Polymerizable | D - 1 | 0 | 0 | 0 | 0 | 0 | 0 | 0 | 0 | 0 | 10.2 | 0 |
| Compound D | D - 2 | 0 | 0 | 0 | 0 | 0 | 0 | 0 | 0 | 0 | 0 | 10.2 |
| | D - 3 | 0 | 0 | 0 | 0 | 0 | 0 | 0 | 0 | 0 | 2 | 2 |
| | D - 4 | 0 | 0 | 0 | 0 | 0 | 0 | 0 | 0 | 0 | 2 | 2 |
| | D - 5 | 0 | 0 | 0 | 0 | 0 | 0 | 0 | 0 | 0 | 0.1 | 0.1 |
| | D - 6 | 0 | 0 | 0 | 0 | 0 | 0 | 0 | 0 | 0 | 0.1 | 0.1 |
| Polymerization | F - 1 | 0 | 0 | 0 | 0 | 0 | 0 | 0 | 0 | 0 | 0.1 | 0.1 |
| Initiator E | | | | | | | | | | | | |
| Dispersant F | f - 1 | 0.5 | 0.5 | 0.5 | 0.5 | 0.5 | 0.5 | 0.5 | 0.5 | 0.5 | 0.5 | 0.5 |
| Average Tc heat quantity (mJ/mg) | | 0.55 | 0.55 | 0.55 | 0.55 | 0.55 | 0.55 | 0.56 | 0.61 | 0.05 | 0.55 | 0.55 |
| Dielectric constant of binder alone (—) | | 4.5 | 4.4 | 4.5 | 4.5 | 4.2 | 4.2 | 4.5 | 4.6 | 4.5 | 3 | 2.4 |
| Evaluation | Composition viscosity (Pa · s) | 50.4 | 28.4 | 27.5 | 26.7 | 60.4 | 40.1 | 31.3 | 285.1 | 104.4 | 294 | 1000 |
| | Tensile elastic modulus (MPa) | 20 | 9 | 5 | 2 | 98 | 41 | 20 | 24 | 20 | 23 | 9 |
| | Piezoelectric constant d₃₃ | 140 | 105 | 60 | 20 | 62 | 112 | 141 | 171 | 13 | 30 | 24 |
| | Evaluation based on the | S | S | A | A | S | A | S | S | B | B | B |
| | relationship between tensile | | | | | | | | | | | |
| | elastic modulus and piezoelectric | | | | | | | | | | | |
| | constantd₃₃ | | | | | | | | | | | |

TABLE 2

| | | Example | | | | | | |
|---|---|---|---|---|---|---|---|---|
| | | 9 | 10 | 11 | 12 | 13 | 14 | 15 |
| Piezoelectric | A 1 - 1 | 85 | 0 | 0 | 0 | 67.1 | 0 | 39 |
| Particles A | A 1 - 2 | 0 | 85 | 80 | 70 | 0 | 0 | 39 |
| | A 1 - 3 | 0 | 0 | 0 | 0 | 0 | 85 | 0 |
| | A 1 - 4 | 0 | 0 | 0 | 0 | 17.9 | 0 | 0 |
| | A 1 - 5 | 0 | 0 | 0 | 0 | 0 | 0 | 5 |
| | A 1 - 6 | 0 | 0 | 0 | 0 | 0 | 0 | 2 |
| | A′- 1 | 0 | 0 | 0 | 0 | 0 | 0 | 0 |
| Epoxy Resin B | B - 1 | 13.5 | 13.5 | 18.1 | 27.4 | 13.5 | 13.5 | 13.5 |
| | B - 2 | 0 | 0 | 0.0 | 0.0 | 0 | 0 | 0 |
| Curing Agent C | C - 1 | 0 | 0 | 0 | 0 | 0 | 0 | 0 |
| | C - 2 | 0 | 0 | 0 | 0 | 0 | 0 | 0 |
| | C - 3 | 1.0 | 1.0 | 1.4 | 2.1 | 1.0 | 1.0 | 1.0 |
| Polymerizable | D - 1 | 0 | 0 | 0 | 0 | 0 | 0 | 0 |
| Compound D | D - 2 | 0 | 0 | 0 | 0 | 0 | 0 | 0 |
| | D - 3 | 0 | 0 | 0 | 0 | 0 | 0 | 0 |
| | D - 4 | 0 | 0 | 0 | 0 | 0 | 0 | 0 |
| | D - 5 | 0 | 0 | 0 | 0 | 0 | 0 | 0 |
| | D - 6 | 0 | 0 | 0 | 0 | 0 | 0 | 0 |
| Polymerization | F - 1 | 0 | 0 | 0 | 0 | 0 | 0 | 0 |
| Initiator E | | | | | | | | |
| Dispersant F | f - 1 | 0.5 | 0.5 | 0.5 | 0.5 | 0.5 | 0.5 | 0.5 |
| Average Tc heat quantity (mJ/mg) | | 0.57 | 0.53 | 0.53 | 0.53 | 0.47 | 0.23 | 0.63 |
| Dielectric constant of binder alone (—) | | 4.5 | 4.5 | 4.5 | 4.5 | 4.5 | 4.5 | 4.5 |
| Evaluation | Composition viscosity (Pa · s) | 20.0 | 89.8 | 31.6 | 5.8 | 27.5 | 50.4 | 60.4 |
| | Tensile elastic modulus (MPa) | 20 | 20 | 20 | 20 | 20 | 20 | 20 |
| | Piezoelectric constant d₃₃ | 70 | 130 | 62 | 32 | 81 | 40 | 70 |
| | Evaluation based on the | A | S | A | A | S | A | A |
| | relationship between tensile | | | | | | | |
| | elastic modulus and piezoelectric | | | | | | | |
| | constantd₃₃ | | | | | | | |

1. A curable resin composition comprising piezoelectric particles (A1) having a Curie temperature (Tc) of 0.15 mJ/mg or more; an epoxy resin (B); and a curing agent (C).

2. The curable resin composition according to claim 1, wherein a cured product at a thickness of 200 μm obtained by heating the curable resin composition at 80° C. for 3 hours and at 140° C. for 3 hours to effect curing has a tensile elastic modulus of 100 MPa or less.

3. The curable resin composition according to claim 1, wherein the epoxy resin (B) comprises an epoxy resin (B1) having a viscosity of 500 mPa's or less as measured at 25° C.

4. The curable resin composition according to claim 1, wherein the epoxy resin (B) comprises an epoxy resin (B2) represented by Formula (1): 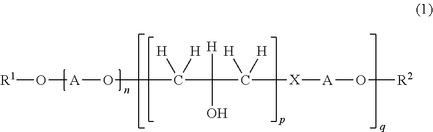
wherein, in Formula (1), A is a divalent alkylene group represented by —[(CH₂)ₘ]—, m independently at each occurrence representing an integer from 1 to 10; R¹ and R² are each independently a hydrogen atom or a glycidyl group, at least one of R¹ and R² being a glycidyl group; X represents a single bond, —O—, or —O-A-; n is an integer from 0 to 20; p is 0 or 1; and q is an integer from 0 to 20.

5. The curable resin composition according to claim 3, wherein the proportion of the epoxy resin (B1) relative to the total amount of the epoxy resin (B) contained in the curable resin composition is 60 to 100% by mass.

6. The curable resin composition according to claim 1, wherein the piezoelectric particles (A1) are barium titanate.

7. The curable resin composition according to claim 1, wherein the proportion of the piezoelectric particles (A1) relative to the total amount of the piezoelectric particles (A) contained in the curable resin composition is from 60 to 100% by mass.

8. The curable resin composition according to claim 1, wherein the mass ratio of piezoelectric particles (A1):epoxy resin (B):curing agent (C) is 65 to 90:5 to 30:0.5 to 5.

9. The curable resin composition according to claim 1, wherein the viscosity measured at 25° C. is 100 Pa's or less.

10. A cured product of the curable resin composition according to claim 1.

11. A piezoelectric body comprising piezoelectric particles (A1) having a Curie temperature (Tc) of 0.15 mJ/mg or more and an epoxy-based binder; wherein the tensile elastic modulus at 25° C. is 100 MPa or less, and the piezoelectric constant d₃₃ is 30 or more.
